(19) United States
(12) Patent Application Publication
(10) Pub. No.: US 2008/0048489 A1
(43) Pub. Date: Feb. 28, 2008

(54) Bicycle rim assembling structure

(76) Inventor: Wen-Pin Liu, Changhua City (TW)

Correspondence Address: RABIN & BERDO, P.C., Suite 500, 1101 14th Street, N.W., Washington, DC, 20005, US

(21) Appl. No.: 11/508,216

(22) Filed: Aug. 23, 2006

(51) Int. Cl. B60B 21/06

(52) U.S. Cl. 301/61

(57) ABSTRACT

A bicycle rim assembling structure includes a plurality of through holes disposed equidistantly at a concave surface on an external side of a rim, and a corresponding number of eyelets are engaged into the through holes by a pressing machine. The eyelet is T-shaped with a distal edge of its broadened circular section at the top bent into an internal wall of a cannular hole, and the lowest section of its linear flat body section at the bottom bent into another cannular hole, and both upper and lower cannular holes have the same diameter, and the eyelets are engaged into the through holes. The space of the linear flat body section under the eyelet provides a function of adjusting the spokes, and the thickness of the eyelet provides sufficient strength to accept the pulling force applied to the eyelet after the spoke is installed to the rim to prevent accidents.

### BACKGROUND OF THE INVENTION

1. Field of the Invention

The present invention relates to a bicycle rim assembling structure, and more particularly to a bicycle rim assembling structure that fixes several eyelets on a bicycle rim and slips the eyelets onto corresponding through holes at a concave surface of the external ring of the bicycle rim, and the broadened circular portion of each eyelet has a thickness of two layers and provides sufficient strength to accept a pulling force of a spoke applied to the eyelets, after the spokes are installed to the rim.

2. Description of the Related Art

In general, a common bicycle rim available in the market as shown in FIG. 1A has a plurality of through holes A1 disposed equidistantly from each other on an external surface of a rim A, and an eyelet B as shown in FIG. 1B engaged to a distal opening of every through hole A1, and then a punch pin of a rivet machine is pressed downward to fix the eyelets B to the through holes A1 of the rim, and a thread section C1 at another end of a spoke C disposed at an end of the hub A2 is passed into the eyelet B disposed at the through hole A1 of the rim A, and then a plug D is passed from the external edge of the rim A and engaged with the through holes A1 as shown in FIGS. 1C and 1D to secure the spoke C into the rim A.

When a punch pin of a rivet machine is pressed downward at the eyelet B, the pressing fore is directly proportional to the cross-sectional thickness of a cannular wall of the eyelet B to broaden the circular surface at the opening of the eyelet B and attached onto the circular surface at the internal side of the rim A, so as to rivet and fix the eyelet B onto the rim A. However, the machine of such arrangement will be worn out easily after the machine has been used for a while, particularly when the machine is operated for the downward pressing task. Furthermore, the electric power consumption will be increased and the life expectancy of the machine will be lowered. When an end of the spoke C is passed into the eyelet B at the through hole A1, the spoke C is extended from the hub A2 into the through hole A1 of the rim A without a high precision, so that it is necessary to slightly tilt the eyelet B for connecting the spoke C into the eyelet B of the through hole A1. However, it is not easy to tilt the eyelet B, and the connection may be misaligned and require a slight adjustment or balance, or the spoke C may be loosened or broken easily during the process of turning and mounting the spoke C into the rim A, and thus it is very unsafe.

### SUMMARY OF THE INVENTION

The primary objective of the present invention is to overcome the shortcomings of the prior art by providing a bicycle rim assembling structure that comprises a plurality of through holes disposed equidistantly with each other at a concave surface on an external ring of a rim, and a corresponding number of eyelets are engaged with the through holes by a pressing machine. Therefore, the lowest section of the linear flat body section of the eyelet is bent into the cannular hole for facilitating its installation into the through hole disposed at the concave surface of the external ring of the rim, and the space of the linear flat body section under the eyelet is provided for adjusting the installation of a spoke, and the broadened circular portion of the eyelet has a thickness of two layers formed after a distal edge of the broadened circular portion is bent several times to provide sufficient strength to accept a pulling force applied by the spoke onto the eyelet, after the spokes are installed to the rim, so as to prevent accidents.

Another objective of the present invention is to provide a bicycle rim assembling structure, wherein the eyelet is T-shaped with its broadened circular portion at the top bent into an internal wall of a cannular hole, and the lowest section of its linear flat body section at the bottom bent into another cannular hole, and both upper and lower cannular holes have the same diameter.

### BRIEF DESCRIPTION OF THE DRAWINGS

FIG. 1A is an exploded view of a rim assembling position of a prior art;

FIG. 1B is a schematic view of an assembling process of a prior art;

FIG. 1C is a cross-sectional view of an assembly of a prior art;

FIG. 1D is a schematic view of an assembled rim of a prior art;

FIG. 2 is a schematic view of a structure of the present invention;

FIG. 3 is another schematic view of a structure of the present invention;

FIG. 4 is a schematic of an assembling position of the present invention;

FIG. 5 is a schematic view of an assembling process of the present invention;

FIG. 6 is another schematic view of an assembling process of the present invention; and

FIG. 7 is a further schematic view of an assembling process of the present invention.

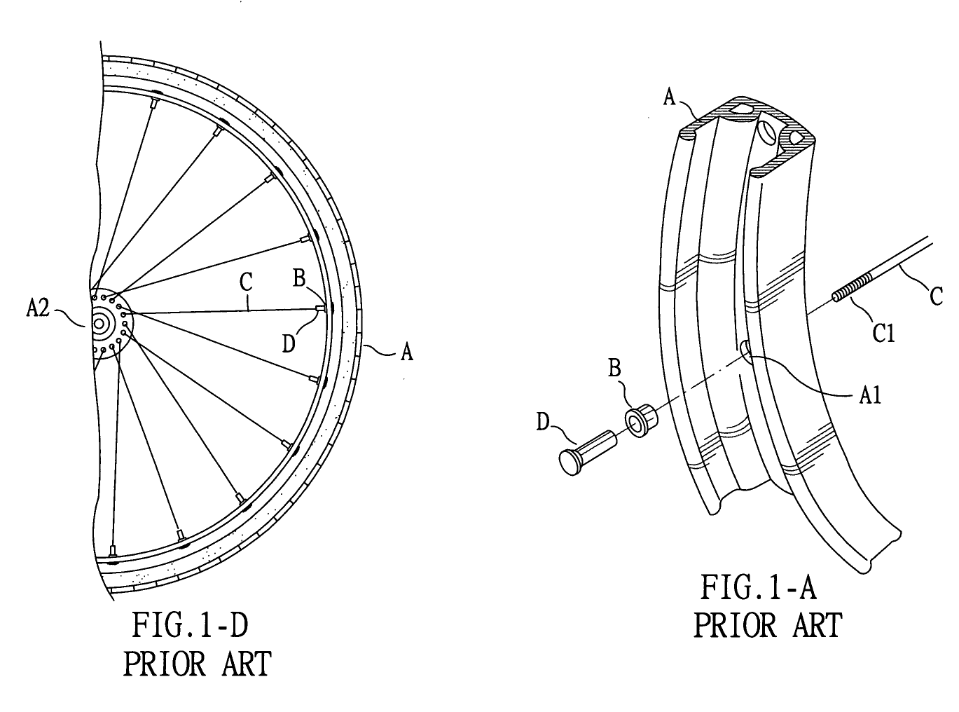

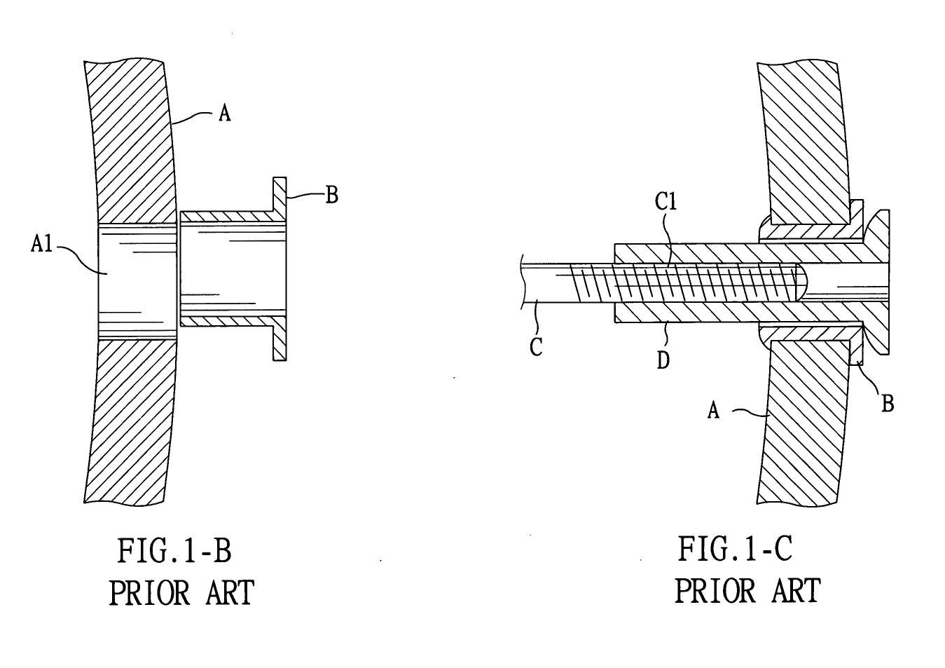

### DETAILED DESCRIPTION OF THE PREFERRED EMBODIMENTS

The above and other objects, features and advantages of the present invention will become apparent from the following detailed description taken with the accompanying drawings.

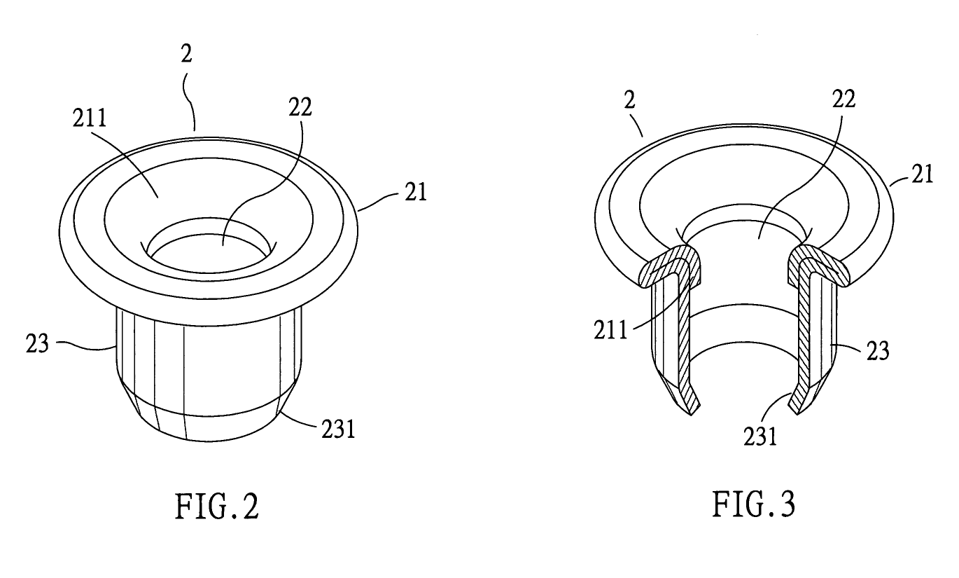

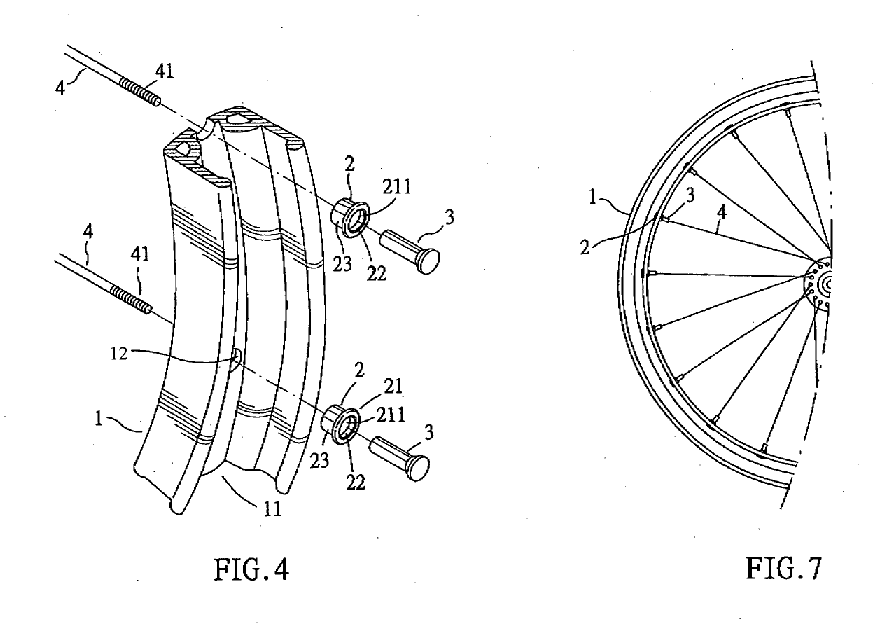

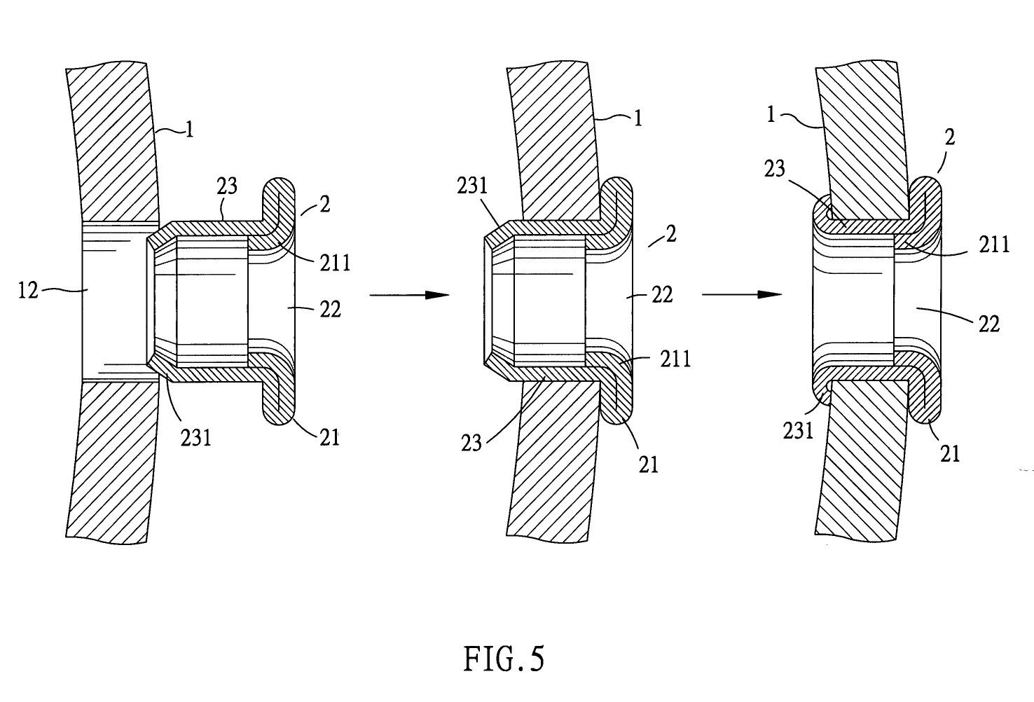

Referring to FIGS. 2 to 4 for a bicycle rim assembling structure of the present invention, the structure comprises a plurality of through holes 12 disposed equidistantly with each other at a concave surface 11 on an external ring of a rim 1 for engaging a corresponding number of eyelets 2 one by one into the through holes 12 by a pressing machine (as shown in FIG. 5). The eyelet 2 is T-shaped with a distal edge 211 of its broadened circular portion 21 at the top bent into an internal wall of a cannular hole 22, and the lowest section of its linear flat body section 23 at the bottom bent into another cannular hole 22, and both upper and lower cannular holes 22 have the same diameter.

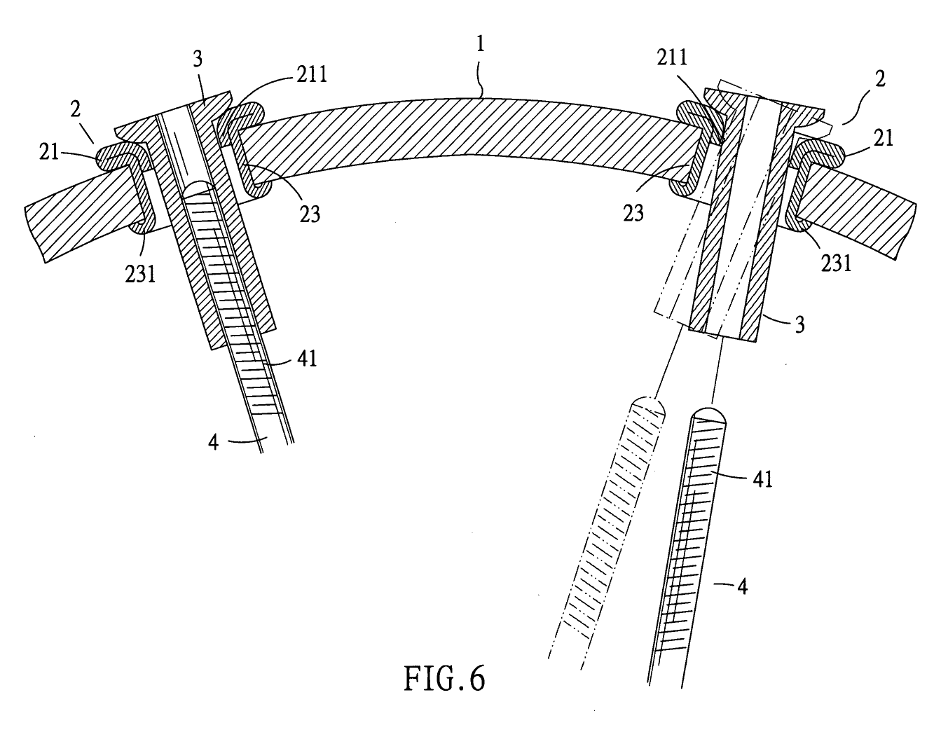

When the eyelets 2 are installed one by one into the through holes 12 at the concave surface 11 at the external ring of the rim 1, a section 231 at the bottom of the linear flat body section 23 under the eyelet 2 is bent to facilitate its installation into the through holes 12 that are disposed at the concave surface 11 of the external ring of the rim 1, and then the pressing action of the pressing machine bends and fixes the section 231 at the lowest portion of the linearly flat body section 23 at the bottom of the eyelet 2 as shown in FIG. 5. When a connecting plug 3 and a spoke 4 are installed at the internal and external positions of the through holes 12 respectively, the pressing machine attaches the section 231 at the lowest portion of the linearly flat body section 23 at the bottom of the eyelet 2 onto the external edge of the through holes 12 disposed on the concave surface 11 at the external ring of the rim 1, so that the diameters of the cannular holes 22 are tapered upward, such that after the connecting plug 3 is passed into the internal wall of the cannular hole 22 of the eyelet 2, the thread section 41 of the spoke 4 is placed into the connecting plug 3 for the connection. Since a distal edge 211 of the broadened circular portion 21 at the top of the eyelet 2 is bent several times to define a thickness of two layers on the internal wall of the cannular hole 22, and the linear flat body section 23 at the bottom has the thickness of one layer, therefore the diameters of the upper and lower cannular holes are tapered upward and used for slightly adjusting the connecting plug 3 and being aligned exactly with the thread section 41 of the spoke 4 as shown in FIGS. 6 and 7, so as to prevent accidents caused by a loosened or broken spoke 4, if the alignment is imprecise or the installation is improper.

In the meantime, the distal edge 211 of the broadened circular portion 21 at the top of the eyelet 2 is bent several times into the internal wall of the cannular hole 22 to define a thickness of two layers that results in a lighter weight and a stronger strength over the prior art, for providing sufficient strength to accept a pulling force applied to the eyelet 2, after the spokes are installed to the rim 1.

In summation of the description above, present invention complies with the patent application requirements, and thus is duly filed for a patent application.

While the invention has been described by means of specific embodiments, numerous modifications and variations could be made thereto by those skilled in the art without departing from the scope and spirit of the invention set forth in the claims.

1. A bicycle rim assembling structure, comprising:
a rim having a plurality of through holes disposed substantially equidistantly from each other; and
a plurality of corresponding eyelets, press-fit into the through holes by pressing equipment, each eyelet having a top section, a bottom section, and a substantially T-shaped configuration, the top section having a broadened circular portion with a distal layer that is bent and extends into an internal wall of an upper cannular hole, and the bottom section including a substantially cylindrical portion followed by a terminal portion that is bent inward to provide a lower cannular hole, the upper and lower cannular holes having diameters that are substantially the same and the substantially cylindrical portion having an inner diameter that is larger,
wherein each eyelet is lodged in its corresponding through hole, the substantially cylindrical portion providing space for adjusting the installation of a spoke, and the broadened circular portion having a thickness of two layers to provide sufficient strength to accept a pulling force applied by said spoke onto the respective eyelet, after said spokes are installed to the rim.

2. An eyelet for use in attaching a spoke to a rim of a wheel at a through hole in the rim, comprising:
a unitary member having a top section, a bottom section, and a cannula that extends through the top and bottom sections,
wherein the top section includes a broadened portion having an outwardly-flaring first layer and a bent-over second layer with an annular part that extends into the cannula and that provides an upper cannular hole having an upper-hole diameter,
wherein the bottom section includes a substantially cylindrical portion followed by a terminal portion that is slopes inward and ends with a lower cannular hole having a lower-hole diameter that is substantially the same as the upper-hole diameter, and
wherein the substantially cylindrical portion of the bottom section has an inner diameter that is greater than the upper-hole diameter and the lower-hole diameter.

3. The eyelet of claim 2, wherein the second layer of the broadened portion is generally funnel-shaped in configuration.
